(19) United States
(12) Patent Application Publication
(10) Pub. No.: US 2026/0354469 A1
(43) Pub. Date: Nov. 12, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban Paz JAUREGUI, London (GB); Mark POTTER, London (GB); Theodora NANNOU, London (GB)

(21) Appl. No.: 19/125,715

(22) PCT Filed: Oct. 24, 2023
(86) PCT No.: PCT/EP2023/079635

§ 371 Date: Apr. 29, 2025

(30) Foreign Application Priority Data
Oct. 31, 2022 (GB) 2216093.1

(51) Int. Cl. A24F 40/46; A24F 40/70; H05B 3/42; H05B 6/10

(52) U.S. Cl. CPC A24F 40/46; A24F 40/70; H05B 3/42; H05B 6/10

(57) ABSTRACT

There is provided a heater for an aerosol provision device configured to heat an aerosol generating article comprising aerosol generating material. The heater comprises a housing, an elongated support and a heating coil. The housing defines an article contact surface. The elongate support is in the housing. The heating coil extends in the housing and around at least part of the elongate support. The elongate support supports at least part of the heating coil and defines a void within a volume defined by the heating coil.

### CROSS-REFERENCE TO RELATED APPLICATIONS

This present application is a National Phase entry of PCT Application No.

PCT/EP2023/079635, filed Oct. 24, 2023, which claims priority from GB 2216093.1, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of assembling a heater.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided a heater for an aerosol provision device configured to heat an aerosol generating article comprising aerosol generating material, comprising: a housing defining an article contact surface; an elongate support in the housing; a heating coil extending in the housing and around at least part of the elongate support, wherein elongate support supports at least part of the heating coil and defines a void within a volume defined by the heating coil.

The article contact surface may define a heating surface.

The elongate support may be tubular.

The elongate support may comprise a hollow tube.

The void may be defined by the hollow tube.

The void may defined by an inner surface of the tube.

The support may comprise a plurality of arms extending from a central portion.

The void may be defined between adjacent arms of the plurality of arms.

The void may be one of a filled void and a partially filled void.

The elongate support may be configured to centre the heating coil within the housing.

The housing may comprise an overlay formed over the heating coil.

The overlay may be an overformed member.

The overformed member may be formed by overmoulding or casting.

The overlay may be an enveloping member.

The enveloping member may be formed by a wrap.

The wrap may include a sheet of material. The sheet of material may be a film.

The housing may comprise a preformed member.

The preformed member may be a casing.

The preformed member may be configured to receive the heating coil.

The preformed member may define an inner void.

The volume defined by the heating coil may be defined within the inner void.

The housing may comprise a thermally conducting material.

The elongate support may comprise a thermally insulating material.

The elongate support may be electrically insulating.

The housing may be electrically insulating.

The elongate support may be integral with or fixed to the housing.

The elongate support may extend from an end of the housing. The elongate support may upstand in the housing from a closed end.

The heating coil may comprise a helical coil portion. The heater may comprise a return electrical path.

The elongate support may space at least a portion of the return electrical path from the helical portion.

At least a portion of the article contact surface may comprise a low friction material.

The low friction material may be provided by a coating or a surface finish.

At least 50%, at least 70% or at least 80% of the article contact surface may comprise the low friction material.

The article contact surface may have a coefficient of friction of less than 1.4, of less than 0.7 or of less than 0.15.

The low friction material may comprise one or more of a diamond-like-carbon (DLC), copper, glass, graphite, aluminium and aluminium magnesium boride (BAM).

The heater may be a resistive heating heater.

The heating coil may be a resistive heating coil.

The heater may be an inductive heating heater.

The heating element may be an inductive heating element.

The coil may be an inductive coil.

According to an aspect, there is provided an aerosol provision device configured to heat an article comprising aerosol generating material, the device comprising a heater as described above. The aerosol provision device may comprise a heating chamber, in which the heater is provided.

According to an aspect, there is provided an aerosol provision device configured to heat an aerosol generating article comprising aerosol generating material, comprising: a receptacle arranged to receive at least a portion of the aerosol generating article; a heating member extending in the receptacle, the heating member comprising an elongate support extending in the receptacle and a heating coil around at least part of the elongate support, wherein the elongate support supports at least part of the heating coil and defines a void within a volume defined by the heating coil.

The aerosol provision device may comprise a power source, a controller and a heating chamber, in which the aerosol generating article is removably received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect there is provided a method of assembling a heater for an aerosol provision device configured to heat an aerosol generating article comprising aerosol generating material, comprising: arranging a heating coil around at least part of an elongate support such that the elongate support supports at least part of the heating coil and defines a void within a volume defined by the heating coil, the method further comprising at least one of: inserting the heating coil and the elongated support in at least a portion of a housing and forming at least a portion of a housing around the heating coil and the elongated support, wherein the housing defines an article contact surface and wherein the heating coil extends in the housing.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4;

FIG. 7 shows a perspective view of an elongated support for a heater;

FIG. 8 shows a schematic cross-sectional view of a heater comprising the elongated support of FIG. 7; and

FIG. 9 shows a flowchart for a method of assembling a heater for an aerosol provision device.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material.

In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

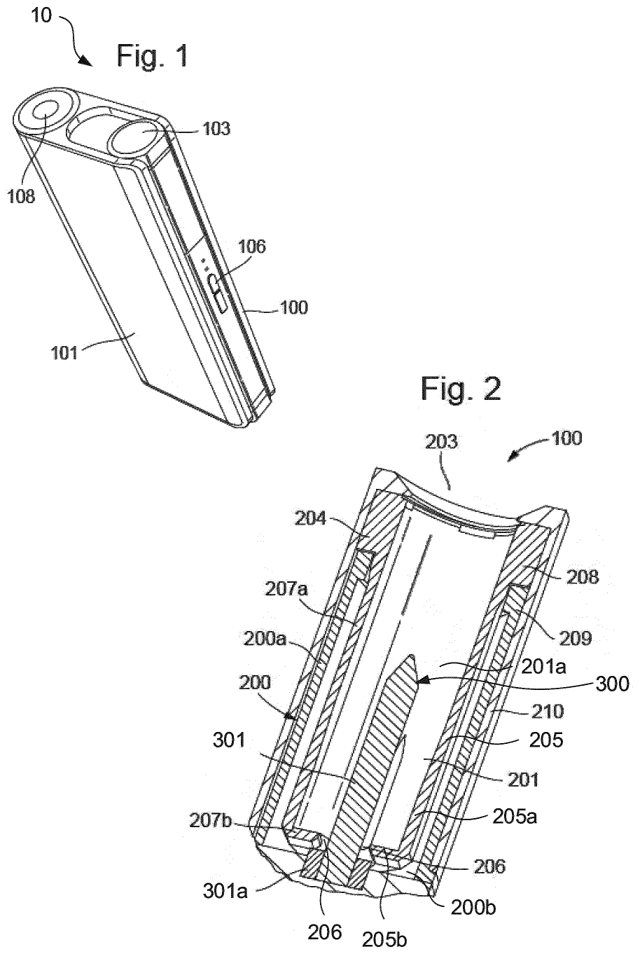

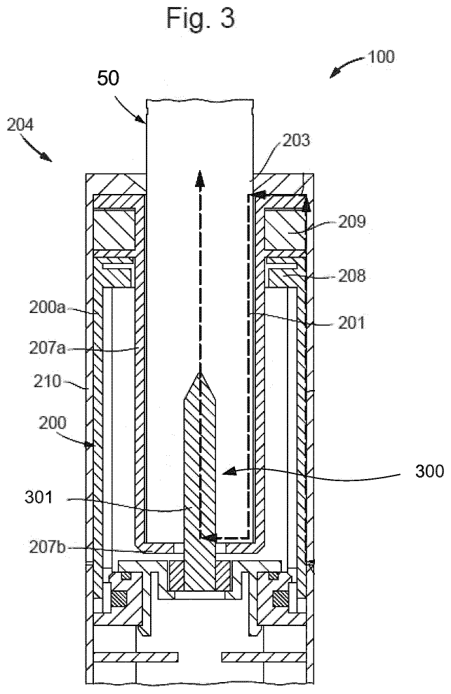

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross-sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured to receive at least a portion of the article for heating.

A heating member 301 is provided in a portion of the main housing 200 and the heating member 301 extends or projects into the heating chamber 201. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The heating member 301 in other embodiments comprises other elongate configurations, such as a blade. The heating member 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base 205b. An aperture 206 is formed in the receptacle base 205b through which the heating member 301 protrudes. In embodiments, the heating member 301 is mounted to the receptacle base 205b. The heating member 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

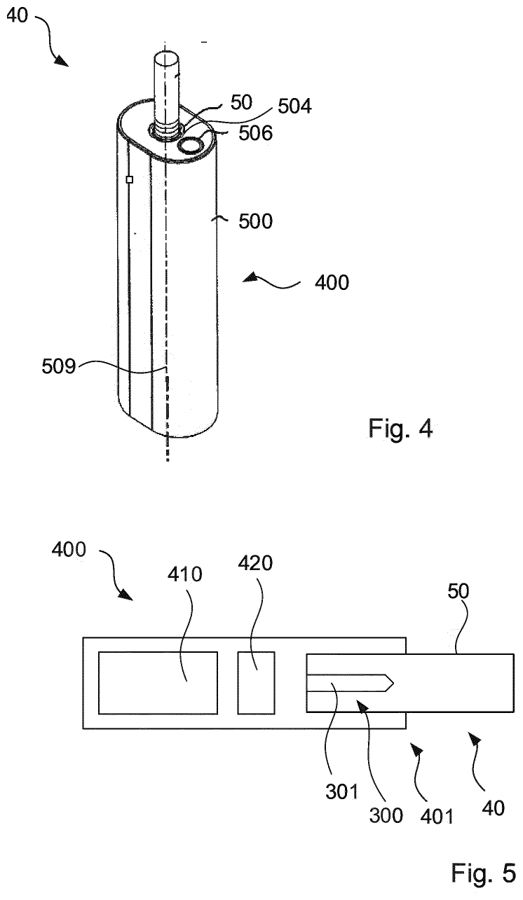

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 400. Features described with reference to FIG. 5 in embodiments are applicable to embodiments described above. The aerosol provision device comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol provision device 400, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article which is received within the heating chamber 401 in order to internally heat the aerosol generating article.

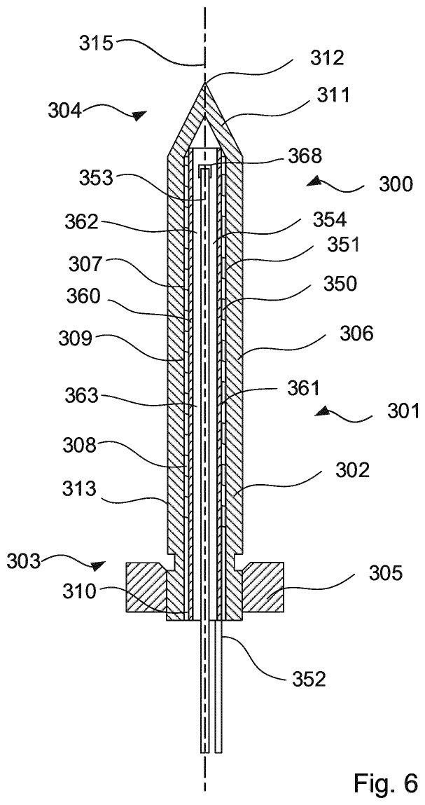

The aerosol provision devices 100, 400 comprise a heating arrangement 300. The heating arrangement 300 comprises a heater. The heating member 301 acts as the heater. The heater comprises a heating element 350 (refer to FIG. 6), for example, including a resistive heating coil, arranged to be actuated to heat the heating member.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises a housing 302 and the heating element 350.

The housing 302 is formed from a thermally conductive material, such as aluminium. Other suitable materials, such as stainless steel or ceramic may be used. The housing 302 is configured to transfer heat from the heating element 350 to the heating zone 201a. The housing 302 extends around the heating element 350. The housing 302 at least partially encapsulates the heating element 350. In embodiments, the housing 302 is at formed from an electrically insulating material. In embodiments, the housing 302 comprises an electrically insulative coating, such as a ceramic, to electrically insulate the housing 302 from the heating element 350. The coating may comprise a vitreous layer. The coating has a thickness of less than 200 μm. The coating may be a vitreous glaze. The coating may comprise a vitreous enamel layer. The coating, in embodiments, is a vitreous substance bonded on the housing 302. In embodiments, the housing 302 is provided with an electrically insulative surface finish, for example a surface of the housing 302 may be anodized.

The housing 302 is an elongate member defining a longitudinal axis 315. The housing 302 has a base end 303 and a free end 304. The base end 304 mounts to the device body. A mount 305 at the base end 303 mounts the heating member 301. It will be understood that different mounting arrangements may be used, for example a fixing, moulding, and bonding including adhering. The mount 305 may be a separate component or may be integrally formed with the housing 302.

The free end 304 of the housing 302 extends towards the proximal end of the heating chamber 201, 401. The free end 304 of the heating member 301 is closed. A tip 311 is provided at the free end 304. The tip 311 extends to an apex 312. Other shapes and configurations of the tip 311 may be provided, for example the tip 311 may define a planar surface.

The heating element 350 extends in the heating member 301. The heating element 350 extends in the housing 302. The heating element 350 extends between the base end 303 and the distal end 304. In embodiments, the heating element 350 extends partially along the length of the housing 302. In embodiments the heating element 350 extends to or beyond the base end 303.

The heating member 301 comprises an elongate support 360. The elongate support 360 is an elongated member defining a longitudinal axis. The longitudinal axis of the elongate support 360 is coaxial with the longitudinal axis 315 of the housing 302. The elongate support 360 extends within the housing 302. In embodiments, the elongate support 360 extends partially along the length of the housing 302. In embodiments the elongate support 360 extends to or beyond the base end 303.

The elongate support 360 supports the heating element 350. At least a portion of the elongate support 360 is in contact with at least part of the heating element 350. The elongate support 360 is a rigid element. The elongate support 360 is self-supporting. The heating element 350 is arranged to at least partially surround the elongate support 360. The heating element 350 extends in the housing 302 and around at least part of the elongate support 360.

The heating arrangement 300 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths are integrally formed with the heating element, for example as a single wire. In embodiments, connectors connect the electrical connection paths with the heating element 350. The heating element 350 is formed from a resistive material, such as a nickel/chrome alloy such as nichrome 80/20 (80% Nickel, 20% Chromium), an iron/chrome/aluminium alloy, or a copper/nickel alloy.

The heating element 350 in embodiments comprises a heating coil 351. The heating coil 351 comprises a resistive member defining the heating coil 351. In embodiments, the heating coil 351 comprises an electrically insulative coating, such as a ceramic, to electrically insulate the heating coil 351 from the housing 302. The electrically insulative coating in embodiments is thermally conductive to provide for heat transfer from the heating element 350 to the housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the housing 302. In embodiments, the electrically insulative member is provided by the housing 302.

The heating coil 351 is a resistive heating coil. The heating coil 351 is a helical coil. The heating coil 351 comprises a helical portion. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

The heating coil 351 is wound helically around the elongate support 360. The heating coil 351 surrounds the elongate support 360. The heating coil 351 defines a longitudinal axis. The longitudinal axis of the heating coil 351 is coaxial with the longitudinal axis of the elongate support 360. The heating coil 351 defines a generally tubular shape. The elongate support 360 extends through the centre of the heating coil 351. The elongate support 360 is provided in the centre of the heating coil 351.

It will be appreciated that the elongate support 360 improves the rigidity of the heating member 301. The elongated support 360 acts as an internal support element. The elongate support 360 is arranged to prevent deformation of the heating member 301 during manufacture of the heater and/or during use of the device. However, there is a need to reduce the thermal mass of the heating member 301 in order to improve the heating efficiency of the heater.

The elongate support 360 is formed from a thermally insulating material. The elongate support 360 may be formed from a suitable material, such as a ceramic or silicone material. Other suitable materials are possible. The elongate support 360 is configured to restrict heat transfer between the heating element 350 and other components of the heating arrangement 300. Forming the elongate support 360 from a thermally insulating material improves the heating efficiency of the heating arrangement. Advantageously, this configuration promotes heat transfer between the heating element 350 and the housing 302. In embodiments, the elongate support 360 is formed from an electrically insulating material. In embodiments, the elongate support 360 comprises an electrically insulative coating, such as a ceramic, to electrically insulate the elongate support 360 from the heating element 350.

The elongate support 360 defines a void 362. The heating coil 351 extends around at least part of the elongate element 360 such that the void 362 is defined within the volume 354. The void 362 defines an air gap. In embodiments, the void 362 is at least partially filled, for example with filler. In embodiments, the filler is a thermal paste or another thermally conductive material. In embodiments, the void 362 houses one or more of the electrical connection paths. In embodiment, the return electrical path 353 is housed in the void 362. In embodiments, the elongate support 360 spaces at least a portion of the return electrical path 353 from the heating coil 351. One or more further components may extend in the void 362. The elongate support 360 in such embodiments, acts to space at least part of such further components from the heating coil 351.

In embodiments, the elongate support 360 comprises a tube 361. The tube 361 defines the longitudinal axis of the elongate support 360. The tube 361 is hollow. The inner surface of the tube 361 defines a cavity 363. The cavity 363 acts as the void 362. The cavity 363 defines an air gap. In embodiments, the cavity 363 is at least partially filled, for example with filler. In embodiments, the filler is a thermal paste or another thermally conductive material. In embodiments, the cavity 363 houses one or more of the electrical connection paths. In embodiments, the tube 361 may comprise one or more apertures 368 for passage of the electrical connection paths. The tube 361 has a circular cross-sectional profile. It will be understood that other configurations are possible. In embodiments, the cross-section of the tube 361 is triangular, rectangular or otherwise polygonal.

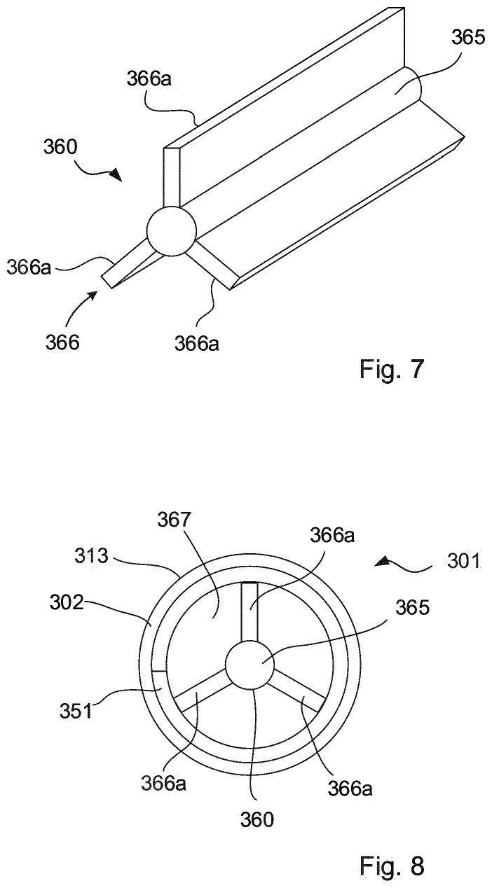

In embodiments, such as the one shown on FIGS. 7 and 8, the elongate support 360 comprises a central portion 365 and an arm arrangement 366. The arm arrangement in embodiments comprises a plurality of arms 366a. The central portion 365 defines the longitudinal axis of the elongate support 360. The central portion 365 is elongated. The central portion 365 is generally cylindrical, however other shapes are envisaged. The central portion 365 is defined as the juncture of two or more of the plurality of arms 366a. In embodiments, the cross-section of the central portion 365 is triangular, rectangular or otherwise polygonal. In embodiments, the central portion 365 comprises a hollow tube.

The arm arrangement 366 comprises one or more arms 366a. In the embodiments shown, the plurality of arms 366a comprises three arms. Each arm of the plurality of arms 366a extends from the central portion 365. Each arm of the plurality of arms 366a extends radially outwards from the central portion 365. Each arm of the plurality of arms 366a is in contact with and supports at least part of the heating coil 351. Each arm of the plurality of arms 366a has a longitudinal extent. In embodiments, the or each arm extends in a helical arrangement in the longitudinal direction. The plurality of arms 366a are formed integral to the central portion 365, however other arrangements are envisaged. The elongate support 360 may define a at least one pocket 367. In an arrangement with the plurality of arms, a plurality of pockets are defined. The pocket or plurality of pockets acts as the void 362. Each pocket 367 is defined by the space between adjacent arms 366a. One or more of the pockets 367 may define an air gap. In embodiments, one or more of the pockets 367 may be at least partially filled, for example with filler. In embodiments, the filler is a thermal paste or another thermally conductive material. In embodiments, one or more of the pockets 367 may house one or more of the electrical connection paths.

The housing 302 comprises an article contact surface 313. The article contact surface 313 is an outer surface of the housing 302. At least a portion of the article contact surface 313 is in contact with the aerosol generating material received in the device for heating. The article contact surface 313 defines a heating surface for heating the aerosol generating material. The article contact surface 313 delimits the heating member 301. The article contact surface 313 defines the periphery of the heating member 301. The article contact surface 313 extends between the base end 303 and the free end 304 of the housing 302.

The article contact surface 313 has a low coefficient of friction such as to prevent aerosol generating material from adhering to the heating member 301. Such a surface, for example formed from a coating or finish, aids the provision of a surface that enables self-cleaning upon insertion of an article 50 into the heating chamber 201. In embodiments, the article contact surface 313 comprises a low friction material. In embodiments, the article contact surface 313 may comprise a different material to the main body of the housing 302. The low friction material may be provided by a coating or by a surface finish. In embodiments, the entire body of the housing 302 is provided of a low friction material.

In embodiments, the article contact surface 313 has a coefficient of friction of less than 1.4, of less than 0.7 or of less than 0.15. The low friction material in embodiments forms the article contact surface 313. In embodiments, the low friction material is, for example, diamond-like-carbon (DLC). Other suitable materials include copper, glass, graphite, aluminium and aluminium magnesium boride (BAM). In embodiments, the low friction material comprises copper and the main body of the housing 302 comprises glass. In embodiments, the low friction material comprises one of glass or diamond-like-carbon (DLC) and the main body of the housing 302 comprises a metal, such as aluminium. In embodiments, the low friction material comprises aluminium and the main body of the housing 302 comprises a ceramic. Other combinations of materials are, however, envisaged. The provision of a low friction article contact surface aids with restricting one or more components of the article, such as glycerol adhering to the surface and diminishing the performance of the heater over time.

It will be appreciated that the structural rigidity of the heating element 350 limits the selection of manufacturing processes available for the assembly of the heating member 301. The provision of the elongate support 360 expands the selection of processes available. The provision of the elongate support 360 facilitates assembly of the heating member 301. The elongate support 360 is configured to prevent deformation of the heating element 360 during assembly. In embodiments, the elongate support 360 is arranged to center, or otherwise locate, the heating element 350 in the heating member 301. In embodiments, the provision of an elongate support 360 enables the housing 302 to be formed directly over the heating element 350.

In embodiments, the housing 302 comprises a preformed member 306. The preformed member 306 is tubular. In embodiments, the preformed member 306 is formed from a film or a sheet of thermally conductive material. In embodiments, the preformed member 306 comprises a casing. Other arrangements are envisaged. The preformed member 306 comprises a bore 307. The bore 307 defines an inner void 308 of the heating member 301. The inner void 308 extends longitudinally. In embodiments, the inner void 308 is at least partially filled, for example with a filler. In embodiments, the filler is a thermal paste or another thermally conductive material. In embodiments, the inner void 308 defines an air gap. An inner surface 309 is defined on an inner side of the housing 302. An open end 310 to the inner void 308 is provided at the base end 303. The inner void 308 does not extend through the free end 304. The heating element 350 is received in the inner void 308. The elongate support 360 is received in the inner void 308. In embodiments the heating element 350 extends to or beyond the open end 310. In embodiments, the elongate support 360 extends to or beyond the open end 310. The elongate support 360 is arranged to centre, or otherwise locate, the heating element 350 into the preformed member 306. The volume 354 defined by the heating coil 351 is defined within the inner void 308.

In embodiments, the elongate support 360 is fixed in position relative to the housing 302. In embodiments, the elongated support 360 forms part of the preformed member 306. In embodiments, the elongate support 360 may be mounted to the preformed member 306 by fixing, moulding, or bonding. In embodiments, the elongate support 360 may comprise one or more locating feature for locating against the preformed member 306. In embodiments, the support forms at least part of the tip or base of the housing 302. In such embodiments, a housing portion extends from at least one of the tip and base.

In embodiments, the housing 302 comprises an overlay instead of the preformed member 306. The overlay is formed over the heating element 350. The elongate support 360 supports the heating element 350 during formation of the overlay around the heating element 350. As such, the elongate support 360 is configured to provide the structural stability necessary to form the overlay over the heating element 350.

It will be understood that different arrangements may be used to from the overlay. In embodiments the overlay is an overformed member. The overformed member is formed by overmoulding or casting. In embodiments, the overlay is an enveloping member. The enveloping member is formed by a warp. The wrap may comprise one or more layers of material. In embodiments, the wrap comprises a film or sheet of material. The film or sheet is formed around the heating element 350. In embodiments, the film or sheet is wound around the heating component 350. In other embodiments, the overlay may instead by formed by layering or coating.

The provision of an overlay ensures consistent contact between the heating element 350 and the housing 302. In embodiments, the heating element 350 is held against the elongate support 360 by the overlay.

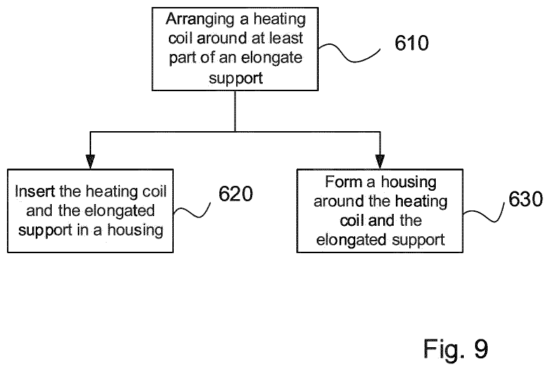

A method of assembling a heater for an aerosol provision device, such as the device 100, 400 is illustrated in FIG. 9. In step 610, a heating coil 351 is arranged around at least part of an elongate support 360 such that the elongate support 360 supports at least part of the heating coil 351 and defines a void 362 within a volume defined by the heating coil 351. In embodiments, the void 362 defines an air gap. In embodiments, the method includes at least partially filling the void 362, for example with a filler. In embodiments, the filler is a thermal paste or another thermally conductive material. In embodiments, the volume defined by the heating coil 351 defines an air gap. In embodiments, the method includes at least partially filling the volume defined by the heating coil 351, for example with a filler. In embodiments, the filler is a thermal paste or another thermally conductive material. The heating coil 351 and the elongate support 360 form a central arrangement. The heating coil 351 may be arranged loosely onto the elongate support 360, however other embodiments are envisaged. For example, the heating coil 351 may be bonded to the elongate support 360 to form the central arrangement. In step 620, the central arrangement is inserted into a housing 302. In step 620, the heating coil 351 and the elongated support 360 are inserted into the housing 302 such that the housing 302 defines an article contact surface 313. In step 620, the heating coil 351 and the elongated support 360 are inserted into the housing 302 so that the heating coil 351 extends into the housing.

Alternatively to step 620, a housing may be formed around the central arrangement (step 630). In step 630, the housing is formed around the heating coil 351 and the elongated support 360 so as to define an article contact surface 313. In step 630, the housing is formed around the heating coil 351 and the elongated support 360 such that the heating coil 351 extends into the housing.

In the above-described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an aerosol generating article comprising aerosol generating material, comprising:
a housing defining an article contact surface;
an elongate support in the housing;
a heating coil extending in the housing and around at least part of the elongate support,
wherein the elongate support supports at least part of the heating coil and defines a void within a volume defined by the heating coil.

2. The heater of claim 1, wherein the article contact surface defines a heating surface.

3. The heater of claim 1, wherein the elongate support is tubular.

4. The heater of claim 1, wherein the support comprises a plurality of arms extending from a central portion.

5. The heater of claim 1, wherein the void is one of a filled void and a partially filled void.

6. The heater of claim 1, wherein the elongate support is configured to centre the heating coil within the housing.

7. The heater of claim 1, wherein the housing comprises an overlay formed over the heating coil.

8. The heater of claim 7, wherein the overlay is an overformed member.

9. The heater of claim 7, wherein the overlay is an enveloping member.

10. The heater of claim 1, wherein the housing comprises a preformed member.

11. The heater of claim 1, wherein the housing comprises a thermally conducting material.

12. The heater of claim 1, wherein the elongate support comprises a thermally insulating material.

13. The heater of claim 1, wherein the heating coil comprises a helical coil portion, wherein the heater comprises a return electrical path, and wherein the elongate support spaces at least a portion of the return electrical path from the helical coil portion.

14. The heater of claim 1, wherein at least a portion of the article contact surface comprises a low friction material.

15. The heater of claim 1, wherein the heater is a resistive heating heater.

16. The heater of claim 1, wherein the heating coil is a resistive heating coil.

17. An aerosol provision device configured to heat an article comprising aerosol generating material, the aerosol provision device comprising the heater of claim 1.

18. An aerosol provision device configured to heat an aerosol generating article comprising aerosol generating material, comprising:
a receptacle arranged to receive at least a portion of the aerosol generating article; and
a heating member extending in the receptacle, comprising:
an elongate support extending in the receptacle; and
a heating coil around at least part of the elongate support,
wherein the elongate support supports at least part of the heating coil and defines a void within a volume defined by the heating coil.

19. A system comprising one of the heater of claim 1, and an article comprising aerosol generating material.

20. A method of assembling a heater for an aerosol provision device configured to heat an aerosol generating article comprising aerosol generating material, comprising:
arranging a heating coil around at least part of an elongate support such that the elongate support supports at least part of the heating coil and such that the elongate support defines a void within a volume defined by the heating coil;
the method further comprising at least one of:
inserting the heating coil and the elongated support in a portion of a housing; and
forming a portion of a housing around the heating coil;
wherein the housing defines an article contact surface and wherein the heating coil extends in the housing.
